(19) United States
(12) Patent Application Publication
(10) Pub. No.: US 2009/0147714 A1
(43) Pub. Date: Jun. 11, 2009

(54) METHOD AND SYSTEM FOR REDUCING POWER CONSUMPTION IN WIRELESS SENSOR NETWORKS

(76) Inventors: Praval Jain, New Delhi (IN); Prashant Aggarwal, New Delhi (IN)

Correspondence Address: CERMAK KENEALY VAIDYA & NAKAJIMA LLP, 515 EAST BRADDOCK RD SUITE B, Alexandria, VA, 22314, US

(21) Appl. No.: 12/099,246

(22) Filed: Apr. 8, 2008

(30) Foreign Application Priority Data
Dec. 5, 2007 (IN) 2559/DEL/2007

(51) Int. Cl. G08C 17/00

(52) U.S. Cl. 370/311

(57) ABSTRACT

The present invention provides a method and system for reducing power consumption in a Wireless Sensor Network. The Wireless Sensor Network includes a plurality of nodes forming a tree structure. The nodes send data towards a root node via parent nodes. The nodes adaptively control the wake-up schedules of radio transceivers based on the network level information of the nodes, thereby reducing the active wake-up interval of the radio transceivers and in turn decreasing the overall power consumption of the Wireless Sensor Network.

### BACKGROUND

This application claims the priority benefit under 35 U.S.C. §119 of Indian Patent Application No. 2559/DEL/2007 filed on Dec. 5, 2007, which is hereby incorporated in its entirety by reference.

The present invention relates to ad-hoc wireless networks. More particularly, the present invention relates to systems and methods for reducing power consumption in ad-hoc Wireless Sensor Networks.

A wireless network can be defined as a network of nodes that exchange data or information amongst each other using wireless communication techniques. An ad-hoc wireless network is characterized by similar behavior of all the nodes present in the wireless network. Ad-hoc wireless networks are also characterized by adaptability of the networks to movement of nodes within the network and the movement of nodes in and out of the network. Nodes can move in and out of the network by entering communication range or by being switched on or off. Wireless networks find varied applications related to real-time sensing, transmission and processing of data. In one application, nodes in wireless networks include sensors to generate data by sensing physical parameters. Such networks having nodes performing tasks of sensing or data generation, along with data processing and data communication, are called Wireless Sensor Networks. A wireless sensor node is capable of sensing physical parameters, examples of which include temperature, pressure, humidity and light intensity and converting them into a format that can be either transmitted wirelessly or stored onto a storage media. Generally, a node in a Wireless Sensor Network forwards the generated data to another node, which in turn forwards it, along with its own generated data, to yet another node. This way, data travels in a hierarchical fashion from one node to another. The data generated by the nodes is destined to a centralized location, where it may be further processed or analyzed.

One advantage of a Wireless Sensor Network is that it is scalable. This means that a wireless sensor node can be added to an existing Wireless Sensor Network on an ad-hoc basis without any manual configuration. Various automation techniques deploy wireless sensor nodes for the purpose of monitoring and require the wireless sensor nodes to be stationed at physically inaccessible locations. Certain applications require the sensors to be moved frequently. This requires high intra-network mobility that can be offered by a Wireless Sensor Network. For example, a Wireless Sensor Network can be employed for tracking inventory in a car factory, where the inventory is mobile and has a wireless sensor attached to it.

Each node in Wireless Sensor Networks is constrained by physical size, battery power and cost. A considerable amount of power is required for powering a wireless radio transceiver that enables wireless data communication within the network. As a result, communication protocols in Wireless Sensor Networks are designed to use the wireless transceivers in wireless sensor nodes efficiently so as to maximize operating life of the wireless sensor nodes. Typically, nodes are constructed to remain active for as long as possible without requiring a change in battery.

Various methods have been developed to minimize the power requirements of a wireless radio transceiver of a node in a Wireless Sensor Network. One way to minimize the power requirements of the wireless radio is by controlling the duration for which the radio actively consumes power. This is typically controlled in accordance with a Medium Access Control (MAC) protocol. For example, a wireless sensor node may keep its wireless radio transceiver in an inactive sleep mode for most of the time and periodically wake up to an active mode for transmitting and receiving data. In the inactive sleep mode the wireless transceiver consumes negligible power.

In one conventional Wireless Sensor Network, wireless sensor nodes adjust their wake-up schedules of radio transceivers based on the sensor temperature in order to overcome the drift and achieve resynchronization. In another conventional Wireless Sensor Network, wireless sensor nodes adjust their transmission rates based on various network level parameters including hop count and battery power.

However, conventional protocols do not control the wake-up intervals adaptively by using network level information in order to optimally use battery power. Examples of network level information include, but are not limited to, the number of children associated with a node and the level of network traffic at the node.

As a result, there exists a need for a Wireless Sensor Network having wireless sensor nodes capable of adaptively controlling the wake-up schedules of the radio transceivers using network level information in order to preserve battery power. It is further desirable to provide a Wireless Sensor Network having high reconfigurability and optimal power usage, using the network level information of the wireless sensor nodes within the network.

### SUMMARY OF THE INVENTION

The present invention is directed to a method and system that provides adaptive radio wake-up schedules in a Wireless Sensor Network based on the network level information. The adaptive radio wake-up schedule optimizes the overall wake-up interval of radio transceivers in nodes of the Wireless Sensor Network, thereby reducing the overall power consumption of the Wireless Sensor Network.

One aspect of the present invention is to provide a Wireless Sensor Network having wireless sensor nodes that use network level information to determine a radio wake-up schedules.

Another aspect of the present invention is to provide a Wireless Sensor Network having wireless sensor nodes associated with each other in a parent-child relationship forming a tree structure and transferring data towards the root node of the tree structure.

Yet another aspect of the present invention is to provide a Wireless Sensor Network capable of being reconfigured such that a wireless sensor node transmits data along a path disjoint from its original path when it needs to change its parent.

To achieve the foregoing objectives, in one embodiment a method for reducing power consumption in a Wireless Sensor Network is provided. In accordance with this method the Wireless Sensor Network includes a plurality of nodes. A node in the plurality of nodes is associated with a first parent node and a set of child nodes. The method includes generating network level information of the node. Based on the network level information, an interval between periodic radio wake-ups is determined. Radio wake-ups are then scheduled based on the interval.

In accordance with another embodiment of the present invention, another method for reducing power consumption in a Wireless Sensor Network is provided. The Wireless Sensor Network includes a plurality of nodes forming a tree structure. A node listens for beacons from a set of nodes that are within a communication range of the node. The node then determines network level information for each of the nodes within communication range using the beacons received from each of the set of nodes. The node determines a first parent node for which the network level information complies with a first set of criteria and then associates with this first parent node.

In accordance with yet another embodiment of the invention, another method for reducing power consumption in a Wireless Sensor Network is provided. This method ensures that wireless sensor nodes in a Wireless Sensor Network remain connected to a root node through disjoint paths. The Wireless Sensor Network has a plurality of nodes forming a tree structure. A node at which the method is practised is associated with a first parent node. The node determines network level information of the first parent node. The network level information of the first parent node includes a route tag of the first parent node. The route tag signifies a disjoint path to the root node. The node listens for beacons from a set of nodes that are within a communication range of the node. From the beacons, the node determines network level information of each of the set of nodes. The network level information of each of the set of nodes includes route tags for the set of nodes. The node then determines a set of second parent nodes from the set of nodes. The second set of nodes are characterized by network level information that complies with a second set of criteria, and have route tags that are different from the route tag of the first parent node. The node then connects to the set of second parent nodes. When network level information of the first parent node complies with a third set of criteria, the node selects a second parent node from the set of second parent nodes. After selecting the second parent node, the node disassociates from the first parent node and associates with the second parent node. To further ensure that it maintains the disjoint path to the root node, the node sets its own route tag same as the route tag of the second parent node.

In accordance with another embodiment of the present invention, a wireless sensor node is disclosed. The wireless sensor node includes a sensor, a transceiver, a signaling module, and a processing module. The sensor is capable of sensing a parameter. The transceiver transmits and receives wireless signals. The wireless signals include beacons and sensed parametric data. The signaling module adaptively controls a wake-up interval of the transceiver based on network level information of the wireless sensor node. The processing module manages connections with other nodes in a Wireless Sensor Network based on the network level information.

In accordance with another embodiment of the present invention, a Wireless Sensor Network is provided. The Wireless Sensor Network includes a gateway and a plurality of nodes. The gateway is capable of accumulating and forwarding data received from the plurality of nodes. The plurality of nodes forms a tree structure with the gateway as the root node. Further, the plurality of nodes includes a set of first level nodes and a set of branches. The set of first level nodes are associated with the gateway. Each of the set of first level nodes is characterized by a unique route tag. Each of the set of branches includes one or more nodes. Further, each branch in the set of branches is associated with a distinct node from the set of first level nodes. Thus, each branch is disjoint from other branches in the set of branches. Each node in a branch is characterized by a route tag that is same as the unique route tag of the distinct node to which the branch is associated.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a Wireless Sensor Network in accordance with one embodiment of the present invention;

FIG. 2 is a block diagram illustrating a part of the Wireless Sensor Network, in accordance with one embodiment of the present invention;

FIG. 3 is a block diagram illustrating a node in the Wireless Sensor Network, in accordance with one embodiment of the present invention;

FIG. 4 is a block diagram illustrating various firmware modules of a microcontroller, in accordance with one embodiment of the present invention;

FIG. 5 is a flowchart illustrating a method for determining interval between periodic wake-ups of a node, in accordance with one embodiment of the present invention;

FIG. 6 is a block diagram illustrating varying wake-up schedules corresponding to different traffic conditions, in accordance with one embodiment of the present invention;

FIG. 7 depicts a beacon packet, in accordance with one embodiment of the present invention;

FIG. 8 is a flowchart illustrating a method for initial association of a node with another node, in accordance with one embodiment of the present invention;

FIG. 9 shows a table that includes various fields received by a node in a beacon, in accordance with one embodiment of the present invention;

FIG. 10 is a flowchart illustrating a method for changing the first parent node, in accordance with one embodiment of the present invention; and

FIG. 11 shows association of a node with a new parent node, in accordance with one embodiment of the present invention.

Those skilled in the art will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF VARIOUS EMBODIMENTS

Before describing in detail embodiments that are in accordance with the present invention, it should be observed that the embodiments reside primarily in combinations and apparatus components related to Wireless Sensor Networks and nodes. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, and the like are used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the present invention provide methods, systems and configurations for reducing power consumption in Wireless Sensor Networks. In one embodiment, a modified Media Access Control (MAC) protocol is provided. In accordance with this MAC protocol, a periodic wake-up of a wireless node is scheduled based on network level information. For example, the amount of traffic being handled by the node can be used to determine the time between periodic wake-ups or a wake-up interval. Thus, when the data being handled by a node is low, the node can reduce its frequency of waking up, thereby reducing battery power consumed. Further, when the data traffic is high, the node can increase its frequency of wake-ups, thereby effectively transmitting more data and avoiding packet drops. This is highly effective in handling burst data, which can be generated by a node whose sensor notes rapidly changing values in sensed parameters and needs to communicate the values to the root node 102. If the wake-up interval is not adjusted, much of the information in the burst data may be dropped at nodes. Packet drops would result in retransmission of packets leading to higher battery power consumption. In another embodiment, a scheme for connecting nodes in a Wireless Sensor Network is provided. A node decides a parent node with which it associates, based on network level information. This scheme ensures equitable distribution of battery consumption in nodes of the Wireless Sensor Network. For example, a node may decide not to associate with a node, as the node has too many existing children. This would increase the number of wake-ups required at this node. The node searches for all nodes that are within range and associates with one based on a set of criteria for network level information. The parent node is selected to reduce the overall power consumption of the network. In yet another embodiment, a reconfigurable Wireless Sensor Network is described. Specifically, a method for changing parents of nodes is provided. A node monitors network level information of its parent nodes. Once the network level information of the parent node with which it is associated meets a set of criteria making the parent unfavorable for data transfer, the node disassociates with the parent node and associates with another parent node. For example, if the battery level of the parent node drops below a threshold, the node disassociates from the parent node and associates with another parent node. In this way, the parent node can continue functioning for a longer duration as its number of children reduces thereby reducing the forwarding load on the parent node. However, the reconfiguration described above ensures that the node is associated with another parent node that lies along a path that is disjoint from its original path. The disjoint path selection ensures that the node does not indirectly start sending data along the same path and distributes the load in the Wireless Sensor Network away from the parent node whose battery level has fallen below the threshold.

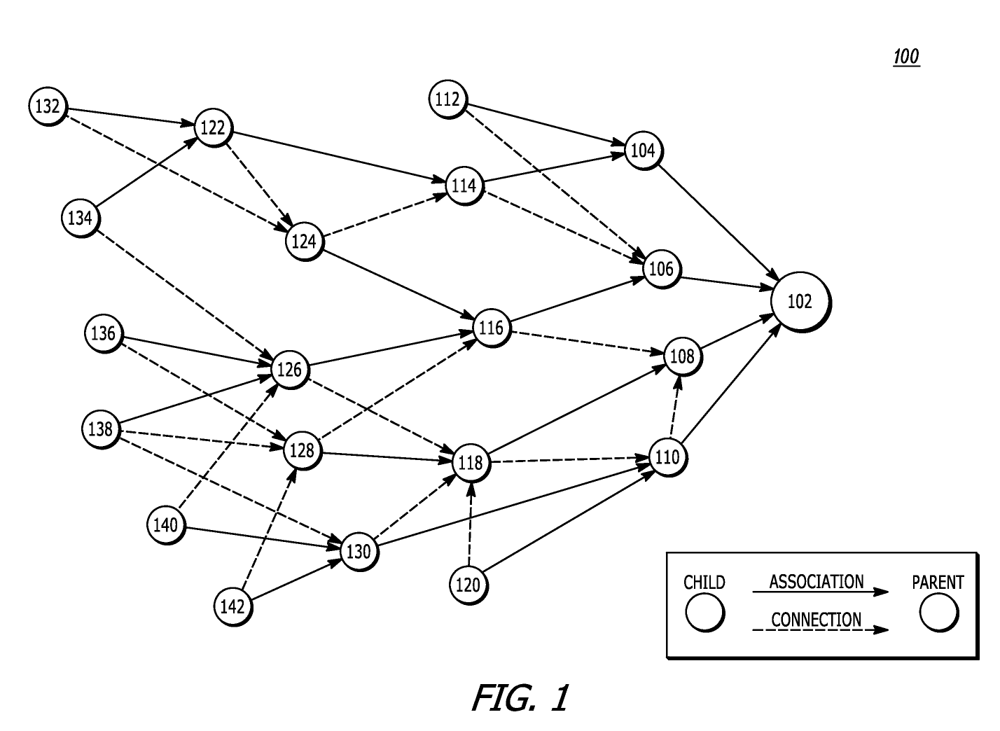

FIG. 1 is a block diagram illustrating a Wireless Sensor Network 100, in accordance with one embodiment of the present invention. The Wireless Sensor Network 100 includes a plurality of nodes forming a tree structure, capable of sensing physical parameters, generating data, receiving data, storing data, and forwarding data towards a root node 102. The plurality of nodes is shown in FIG. 1 to include nodes 104, 106, 108, 110, 112, 114, 116, 118, 120, 122, 124, 126, 128, 130, 132, 134, 136, 138, 140 and 142. It should be apparent to those skilled in the art that the configuration of the Wireless Sensor Network 100 shown in FIG. 1 is for illustrative purposes only. For example, the number of nodes in the Wireless Sensor Network 100 can increase or decrease as the nodes enter and leave the Wireless Sensor Network 100. A node in a Wireless Sensor Network typically handles data traffic that is being merely forwarded or the traffic that is being generated at the node and then forwarded to other node. The data handled by the nodes may include values of sensed physical parameters that include, but are not limited to, temperature, pressure, humidity and light. The data being handled by nodes is eventually forwarded to the root node 102. The root node 102 acts as a gateway for accumulating and forwarding the data. The root node 102 receives the data from the nodes in the Wireless Sensor Network 100 and provides an interface at which the data can be forwarded for analysis. The nodes are related to each other in parent-child relationships, forming a tree with the root node at the top of the tree as shown in FIG. 1. A relationship between two nodes can be an association or a connection. Two nodes are said to be ‘associated’ when one of the nodes is an active parent of the other node, which transmits or forwards data to the active parent. For example, in FIG. 1 the node 112 is associated with the node 104 and this association is shown with a solid arrow. Two nodes are said to be ‘connected’ when one of the nodes is a dormant or redundant parent node of the other node. This other node can form an association with a dormant parent to which it is connected when the active parent with which it is associated becomes unfavorable. It should be noted that a node can have more than one redundant parent nodes. For example, the node 138 is connected to two redundant nodes 128 and 130 and these connections are shown with a dotted arrow. Various nodes in the Wireless Sensor Network 100 may appear at different levels of the tree structure, with a level being determined by the number of associated nodes between a node and the root node 102. For example, the nodes 104, 106, 108 and 110 are the first level nodes and the nodes 112, 114, 116, 118 and 120 are the second level of nodes. It should be apparent to those skilled in the art that the level of a node is not a constant, and can vary when the node changes its active parent node. The number of associated nodes between a node and the root node 102 is referred to as a hop count for the node. In the network shown in FIG. 1, the fourth level nodes are leaf nodes as they have no further children associated with them.

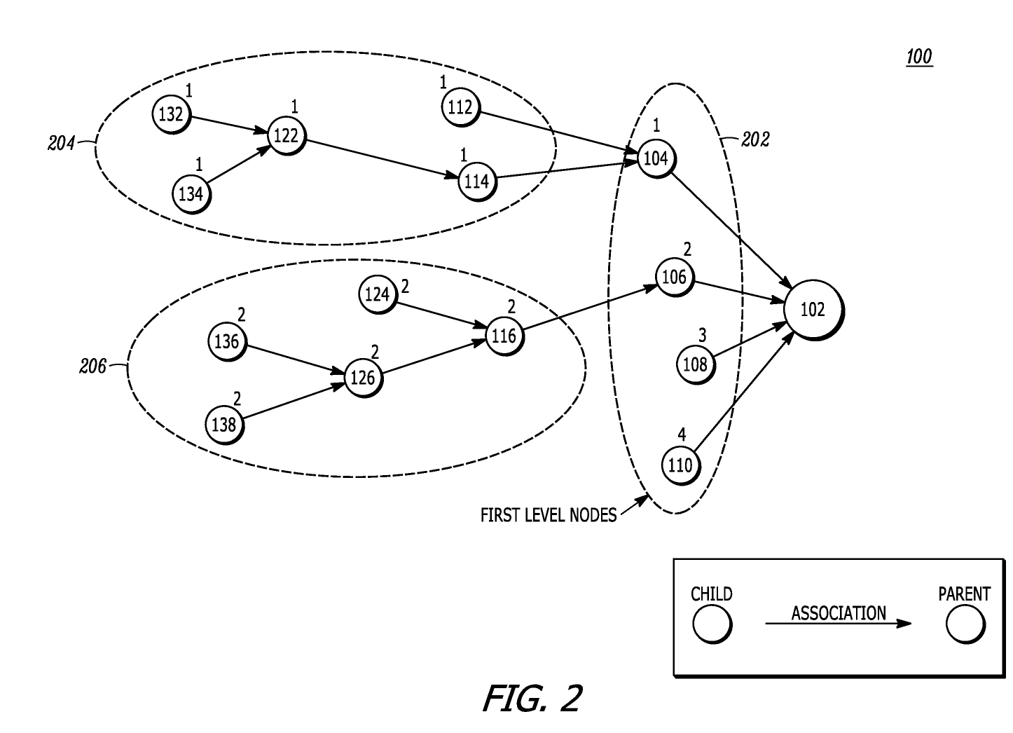

FIG. 2 is a block diagram illustrating a part of the Wireless Sensor Network 100, in accordance with one embodiment of the present invention. In this embodiment of the present invention, the plurality of nodes is shown as branches associated with the first level nodes. For the sake of simplicity, only particular nodes in the Wireless Sensor Network 100 are shown. Further, only associations between nodes are shown. FIG. 2 shows a set of first level nodes 202 that are directly associated with the root node 102 and a branch 204 associated with the node 104 which is part of the set of first level nodes 202. The set of first level nodes 202 also includes the nodes 106, 108 and 110 which are directly connected to the root node 102. The branch 204 includes the nodes 112, 114, 122, 132 and 134 that are directly or indirectly associated with the node 104. It will be apparent to those skilled in the art that similar branches exist for the nodes 106, 108 and 110. It should also be noted that in case no nodes are connected to a first level node, the branch 204 connected to that first level node will be empty. A branch is said to be disjoint from another branch within the same tree if no node is common to either of the branches. Thus, referring to FIG. 1, the branch 204 including nodes 114, 122, 132 and 134, associated with the node 104 is disjoint to another branch 206 including nodes 116, 124, 126 and 136, associated with the node 106. In accordance with various embodiments of the present invention, all the branches associated with the first level nodes are disjoint. In accordance with one embodiment, this disjoint property of different branches is used to assign unique route tags to each of the set of first level nodes and nodes in each of the branches connected to the first level nodes. Further, when a node associates with a parent node, it sets its own route tag as the route tag of the parent node. This ensures that two nodes having different route tags lie in disjoint branches. Thus a route tag signifies a disjoint path to the root node. As described earlier, a node may be connected to one or more redundant parent nodes. In accordance with various embodiments of the invention, the one or more redundant parent nodes have unique route tags. This means that the route tag of each of the one or more redundant parent node is different from the route tag of the parent node with which a node is associated and other route tags of the one or more redundant parent nodes. As a result, a node can only connect to a redundant parent node that lies in a branch that is disjoint with the branch within which the node lies. This ensures that when the node is not able to send data through its parent node, it always associates with and re-tries to send data through a redundant node that has a different association path to the root node 102 and data can always reach the root node 102. This configuration avoids circular paths in the wireless network 100 and also ensures that individual nodes do not get overtly loaded as nodes change their parents in accordance with various other embodiments of the present invention. However, it should be apparent to those skilled in the art that this configuration is not necessary to practice other embodiments of the invention. Any other scheme to avoid circular paths in wireless networks can also be used. It should also be noted, that in case a disjoint path is not available, (i.e., all nodes in communication range of the node have the same route tag) the node will connect to one of the nodes that is most favorable for sending data.

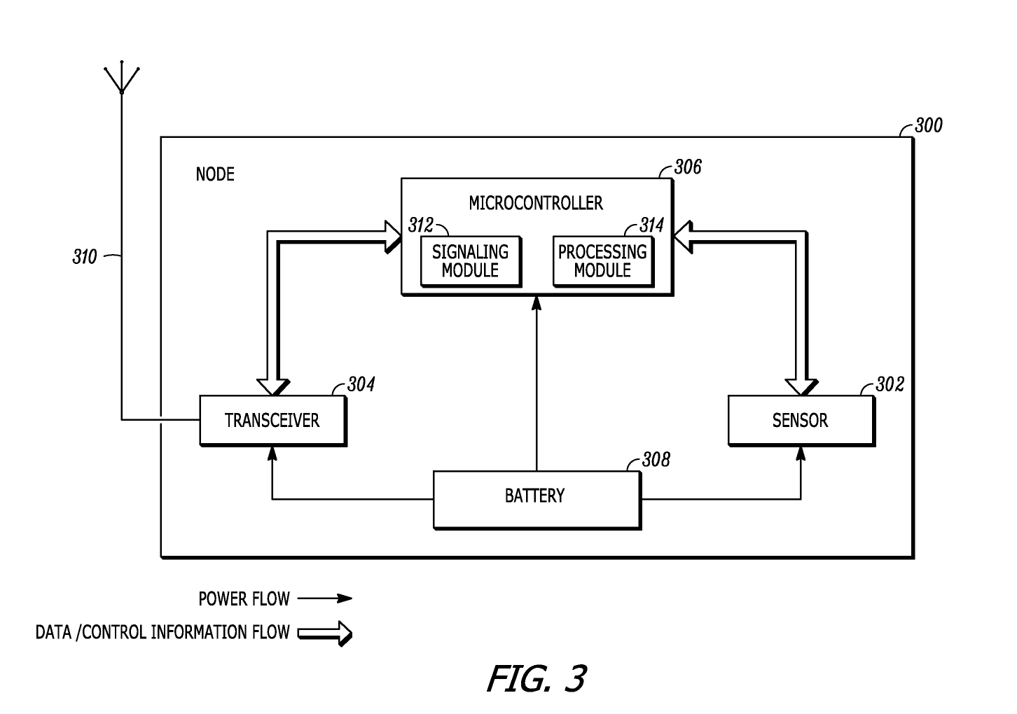

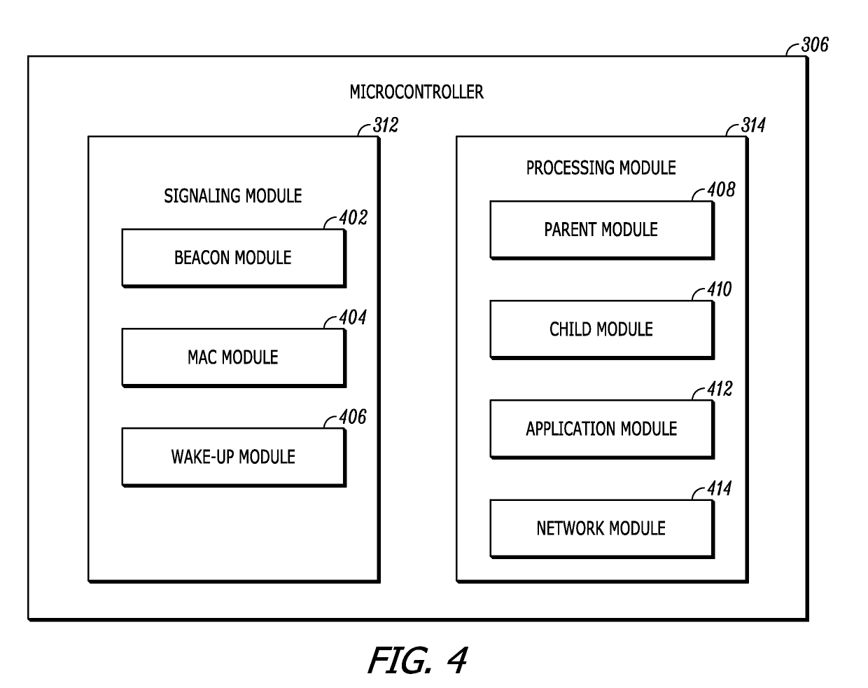

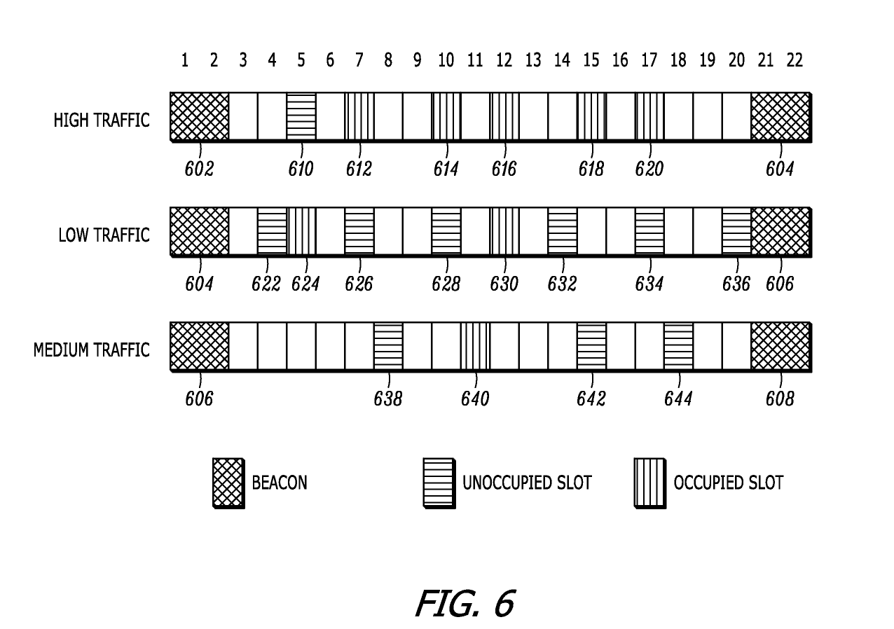

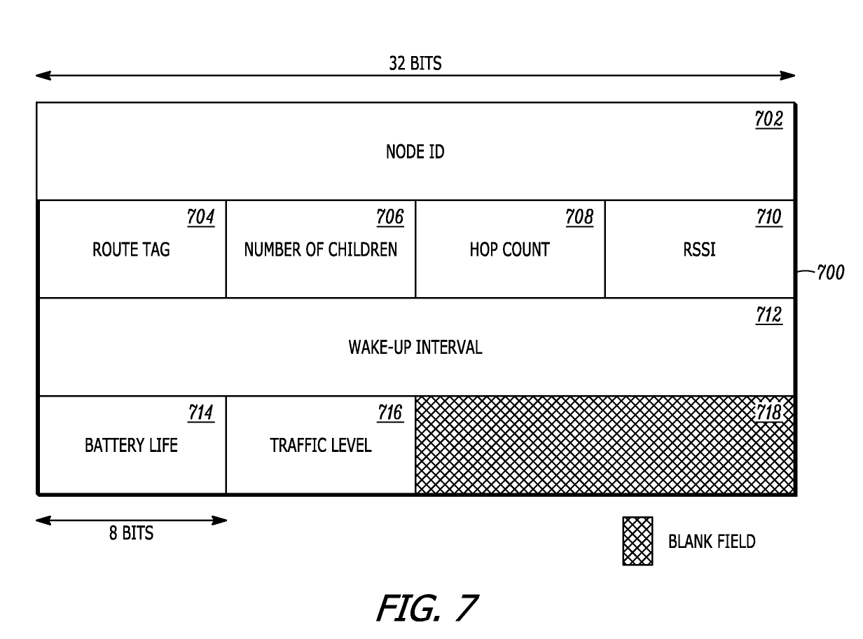

FIG. 3 is a block diagram illustrating a node 300 in the Wireless Sensor Network 100, in accordance with one embodiment of the present invention. The node 300 includes a sensor 302, a transceiver 304, a microcontroller 306 and a battery 308. The sensor 302 is capable of sensing a parameter. The sensor 302 can be a transducer that converts physical parametric measurements into digital data. The physical parameters being sensed can include, but are not limited to, temperature, pressure, humidity and light. The transceiver 304 is connected to a radio antenna 310 for transmission and reception of wireless signals. The wireless signals may be beacons or sensed parametric data. The concept of beacon is explained in greater detail in conjunction with FIG. 6 and FIG. 7. The microcontroller 306 controls the various functionalities of the node 300. The microcontroller 306 includes a signaling module 312 and a processing module 314. The signaling module 312 controls various signaling tasks required for effective communication with other nodes in the wireless network 100. The signaling module 312 adaptively controls wake-up interval of the transceiver 304 based on the network level information of the node 300. The processing module 314 performs various functions like data processing and storage, parent selection, power management, and co-ordination of tasks between various components of the node 300 as shown in FIG. 3. In other words, the processing module 314 manages connections with other nodes based on the network level information. The battery 308 provides power for the functioning of the sensor 302, the transceiver 304 and the microcontroller 306. This is indicated by the thin arrows connecting the battery 308 to these components. The block arrows in FIG. 3 represent the flow of data or control information through the node 300. Data received through the transceiver 304 and made available by the sensor 302 is processed by the microprocessor 306. In accordance with various embodiments of the present invention, the microcontroller 306 can control a wake-up interval of the transceiver 304. The microcontroller 306 uses its own network level information and the network level information it receives from other nodes that it is associated with to determine its wake-up interval. When the transceiver 304 wakes up, it draws power from the battery 308. Similarly, when the microcontroller 306 instructs the transceiver 304 to sleep, the transceiver 304 stops drawing power from the battery 308. It should be noted that all the nodes shown in FIG. 1 and referred to in various embodiments of the present invention are similar to the node 300 as described in conjunction with FIG. 3 in structure and function. The functioning of the microcontroller 306 is described in detail in conjunction with FIG. 4 below.

FIG. 4 is a block diagram illustrating various firmware modules of the microcontroller 306, in accordance with one embodiment of the present invention. The microcontroller 306 includes the signaling module 312 and the processing module 314 as described in conjunction with FIG. 3. Further, the signaling module 312 includes a beacon module 402, a media access control (MAC) module 404 and a wake-up module 406. The processing module 314 includes a parent module 408, a child module 410, an application module 412 and a network module 416.

The beacon module 402 interfaces with the transceiver 304 through the MAC module 404 to receive beacons from various nodes in the communication range of the node 300. Beacons are used to exchange network level information within the Wireless Sensor Network 100. Beacons can be further understood in conjunction with FIG. 6 and FIG. 7. The beacon module 402 also generates beacons to be periodically broadcasted to nodes in the communication range of the node 300. The beacon module 402 works with the network module 406 to determine the network level information of the node 300 to be transmitted in the beacons. The beacon module 402 obtains information received in the beacons from various nodes in the communication range of the node 300. Further, the beacon module 402 provides the information received in the beacons to the parent module 408 for storage purposes. The child module 410 helps the beacon module 402 in determining the number of children, which needs to be broadcasted in the beacons.

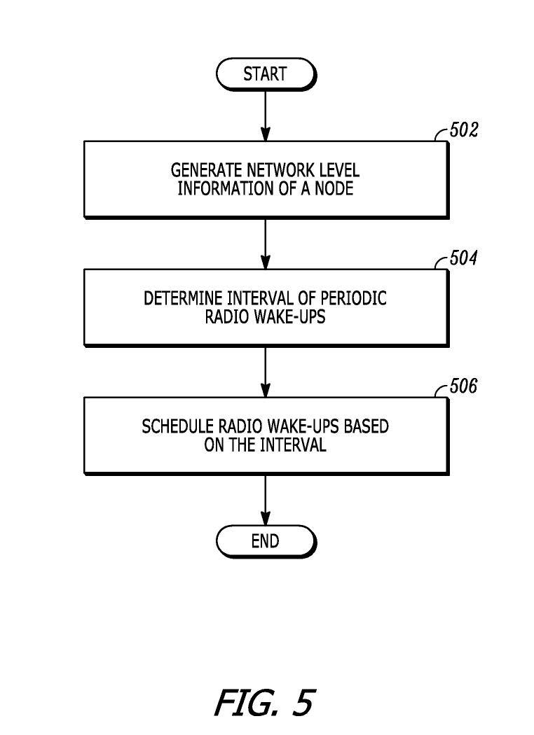

The MAC module 404 controls the access to the transceiver 304 by various modules of the node 300. Further, the MAC module 404 maintains buffers for all the data packets to be transmitted over the Wireless Sensor Network 100. It should be apparent those skilled in art that the MAC module 404 performs other functions as required by the MAC layer in a Wireless Sensor Network. The MAC module 404 further interfaces with the wake-up module 406 to control the wake-up intervals of the transceiver 304 adaptively based on the network level information. This functionality of the MAC module 404 can be better understood in conjunction with the method described in FIG. 5.

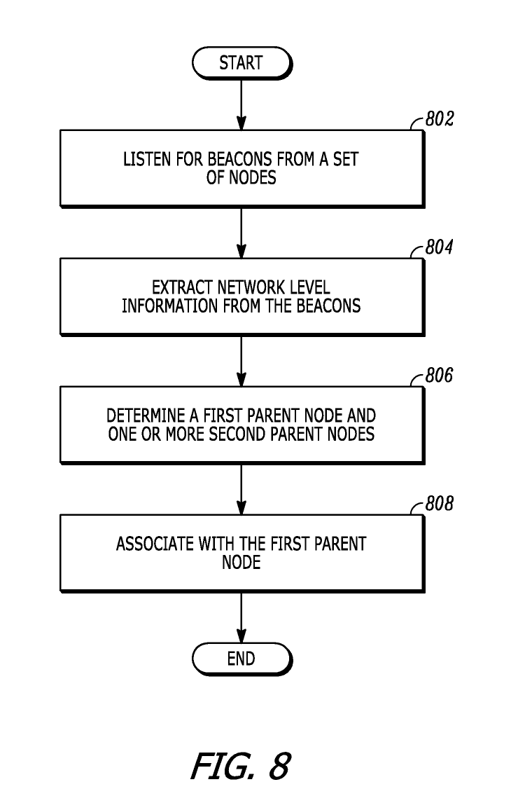

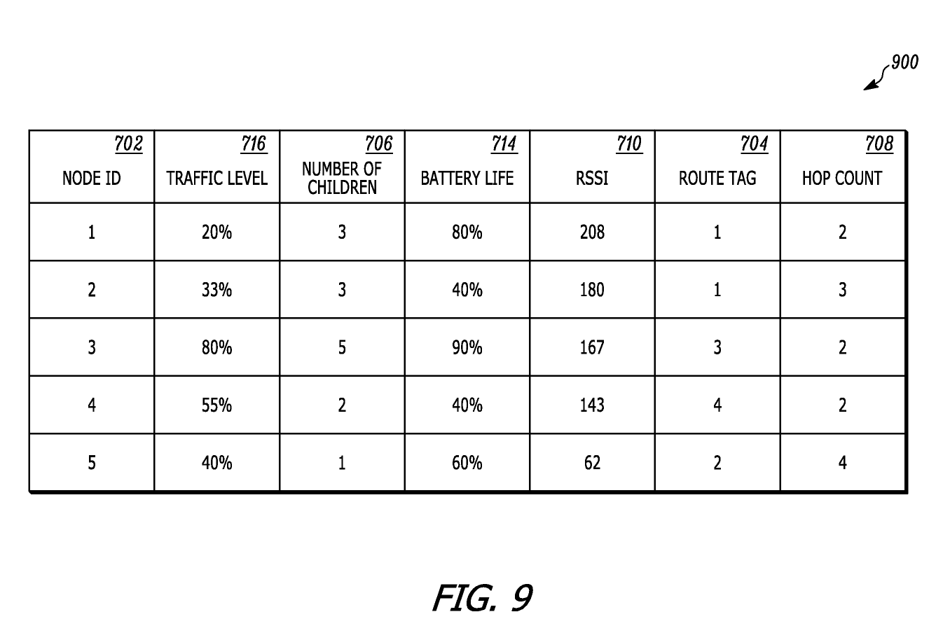

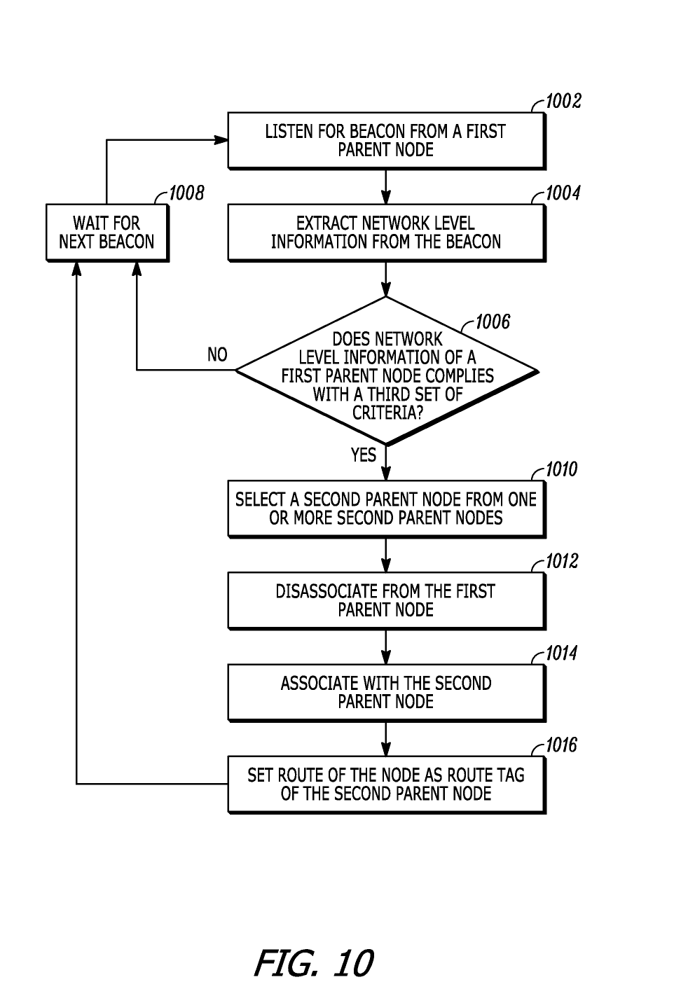

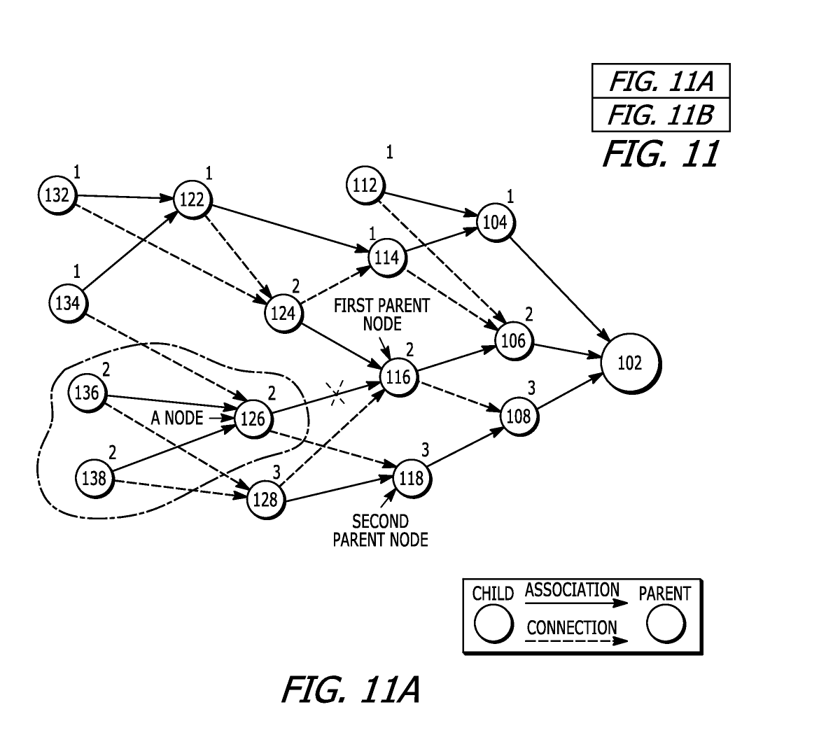

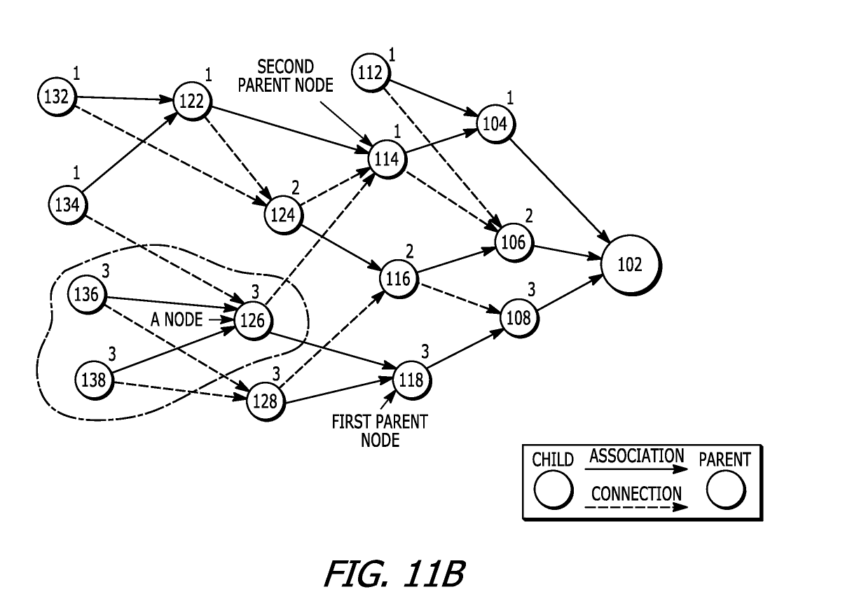

The network module 414 maintains the network level information of the node 300. The network level information may include the number of children associated with the node and the level of network traffic at the node. The examples of network level information can include, but are not limited to, hop-count of the node from the root node, received signal strength indication (RSSI) of the link to the root node, battery level of the link to the root node and duration of past wake-up interval. The network module 414 interfaces with the beacon module 402 to determine some of the network level information, for example, the hop count of the node 300 can be obtained from the hop count of its parent node. The network module 406 further interfaces with the MAC module 404 to determine link information e.g. the received signal strength indication (RSSI). The network module 414 interfaces between the MAC module 404 and the processing module 314. The network module 414 determines the parent node to which the node 300 is associated using the parent module 408. The determination of the parent node to which the node 300 is associated is described in conjunction with FIG. 8 and FIG. 9 below. The network module 414 further determines one or more redundant parent nodes to which the node 300 is connected. When the parent node to which the node 300 is associated with becomes unfavorable for sending data, the network module 414 instructs the node 300 to disassociate with the parent node and associate with a redundant parent node. This is further described in conjunction with FIG. 10 and FIG. 11.

The parent module 408 provides information regarding active parent nodes to the network module 414. The network module 414 obtains the network level information of active and redundant parent nodes from the parent module 408 in order to determine whether to disassociate from the active parent node and which of the redundant parent nodes to associate with. The network module 414 forwards the data received from child nodes to the parent node.

The parent module 408 and the child module 410 maintain lists of parent nodes and children nodes, respectively. The list of parent nodes includes the parent node to which the node 300 forwards data and is associated with. The list of parent nodes also includes one or more redundant parent nodes to which the node 300 can be connected. The list of child nodes and the list of parent nodes are refreshed periodically. The parent module 408 also maintains the network level information for the nodes in the list of parent nodes.

The application module 412 interfaces with the sensor 302 to generate data to be transmitted towards the root node 102. The functionality of these modules is described in conjunction with the method steps shown in FIG. 8 and FIG. 10.

FIG. 5 is a flowchart illustrating a method for determining interval between periodic wake-ups of a node, in accordance with one embodiment of the present invention. At block 502 network level information of the node is generated. The network level information may include the number of children associated with the node and the level of network traffic at the node. Other examples of the network level information include, but are not limited to, hop-count of the node from the root node, received signal strength indication (RSSI), battery level and duration of past wake-up interval. At block 504, an interval of periodic wake-ups of a radio or a radio transceiver is determined. The interval is determined taking into consideration the network level information determined at block 502. At block 506, the radio wake-ups are scheduled based on the interval determined at block 504. Based on this scheduling, the radio of the node wakes-up from a sleep mode to an active mode in order to listen for transmissions from other nodes, including beacons broadcasted by other nodes.

It should be apparent to those skilled in the art that various combinations of network level information can be used to schedule wake-up intervals of the node. Consider, for simplicity, that the wake-up interval is controlled based on the number of children and the traffic level. The number of children can be a measure of contention for radio wake-up slots at a node. If the number of children is low, a node can afford to wake up less frequently saving some of the battery power. Similarly, having low traffic level may lead to wastage of power in periodic radio wake-ups. As a result, reducing the number of radio wake ups may result in saving some of the battery power. The MAC module 404 provides an estimate of network traffic to the wake-up module 406. The wake-up module 406 uses the estimate of network traffic for calculating the periodic wake-up intervals.

FIG. 6 is a block diagram illustrating varying wake-up schedules corresponding to different traffic conditions in accordance with one embodiment of the present invention. FIG. 6 shows three different traffic levels between four consecutive beacons 602, 604, 606 and 608. Between two beacons, a node has 18 time slots in which its radio can wake up and communicate with other nodes. Heavy traffic condition is depicted between beacons 602 and 604. The node wakes up six times at slots 610, 612, 614, 616, 618 and 620. The node receives data at wake-up slots 612, 614, 616, 618 and 620. Awake-up slot in which the node receives data is referred to as an occupied slot and is shown with a vertical hatch. On the other hand, a wake-up slot in which the node does not receive any data is referred to as an unoccupied slot and is shown with a horizontal hatch. As a result, the effective bandwidth utilization may be estimated to be five-sixths or 83.3%. This may be considered as a high traffic situation. In accordance with the method as described above, the node will increase the number of wake-ups between its next two beacons 604 and 606. The node wakes up eight times at slots 622, 624, 626, 628, 630, 632, 634 and 636 as shown in FIG. 6. The node receives data at wake-up slots 624 and 630. As a result, the effective bandwidth utilization may be estimated to be one-fourths or 25%. This may be considered as a low traffic situation. The node will then decrease the number of wake-ups between the beacons 606 and 608. The node wakes up only four times at slots 638, 640, 642 and 644 as shown in FIG. 6. In the subsequent wake-ups, the node may continue estimating effective bandwidth utilization and adaptively scheduling the wake-ups. In the hypothetical situation described above, the network traffic increased and then decreased. The node responded to the varying traffic by first decreasing and then increasing the wake-up interval. Thus, the adaptive wake-up scheme serves to reduce the overall power consumption in two ways. In low congestion parts of the Wireless Sensor Network 100, the wake-up times are more separated and nodes spend more time in sleep mode. In high congestion parts of the Wireless Sensor Network 100, higher bandwidth is supported, thus avoiding buffer overflows and retransmission of packets.

FIG. 6 described adaptive wake-up of a radio in order to save power consumption. A radio wake-up schedule varies as described in the previous paragraph, while the beacons are transmitted at a fixed interval of time. As a special case, a node having no children or a leaf node does not have to wake-up to receive data from other nodes and only needs to send data to its parent. Therefore, leaf nodes may not broadcast beacons as frequently as other nodes do. The interval between two consecutive beacons of leaf nodes may be considerably higher than that of non-leaf nodes. This can further save battery power. It should be noted that a leaf node needs to transmit periodic beacons to allow new nodes to connect to the network. In this way, periodic beacons are like “Hello” messages to nodes trying to join the network. However, leaf nodes do not need to wake up periodically to receive data as they do not have any child nodes. Therefore, leaf nodes do not have a wake-up interval.

It will be apparent to those skilled in the art that a node may use other parameters in a similar way to determine the interval between wake-ups. The network level information may be broadcast by a node to its children and potential children, which are nodes that may want to associate with or connect to the node, as a periodic beacon signal. Typically, a beacon signal includes a beacon packet. The beacon packet is described further in conjunction with FIG. 7. A beacon may be used for a variety of purposes, including synchronization between nodes that are associated or connected.

FIG. 7 depicts a beacon packet 700 in accordance with one embodiment of the present invention. As mentioned above, the beacon packet 700 includes fields that help in synchronization and provide network information for a node. These fields include, but are not limited to, a node identification (ID) 702, a route tag 704, number of children 706, a hop count 708, a received signal strength indication (RSSI) 710, a wake-up interval 712, battery life 714, traffic level 716, and a field 718. In an embodiment, the fields node ID 702 and wake-up interval 712 are 32 bit in length, while the remaining non-blank fields are 8 bits in length. The field 718 is a blank field having a length of 16 bits. In accordance with various embodiments of the present invention, each node is associated with a unique node ID. The node ID 702 field is used to identify a node. The node ID 702 can also be used for authentication at nodes due to the ad-hoc nature of the Wireless Sensor Network 100. The hop count 708 field provides an indication of the number of nodes between a node and the root node 102.

The RSSI 710 is an indication of effective signal strength between the node and a root node. The RSSI 710 may include a number from 0 to 255. A value of 0 for the RSSI 710 indicates that effective signal between the node and the root node is 0. In an embodiment, the RSSI 710 can be calculated as:

RSSI(N,RN)=Min(RSSI(N,PN),RSSI(PN,RN))

where,

N is a node in a Wireless Sensor Network for which the RSSI is to be calculated;

PN is the parent node associated with the node N;

RN is the root node in the Wireless Sensor Network;

RSSI(Node1, Node2) is the RSSI between two nodes in the Wireless Sensor Network;

RSSI(N,PN) is the local RSSI at the node N while receiving the beacon from the parent node PN; and

RSSI(PN,RN) is the RSSI as reported in received beacons from the parent node PN and is equal to the RSSI between the parent node PN and the root node RN.

Therefore RSSI at a particular node is the lowest RSSI of the wireless links between the node and the root node.

Wake-up interval 712 is an interval between two consecutive wake-ups. Through this field, a node informs other nodes regarding its wake-up intervals. Other nodes can then adjust their wake-up intervals according to this wake-up interval in case they wish to send data to the node. The other nodes may even decide whether to continue sending data to a node or start sending to another node. It is this wake-up interval that is adjusted in accordance with an embodiment of the present invention. Therefore, nodes use beacons to advertise their adjusted wake-up intervals.

The battery life 714 is an indication of the amount of battery life remaining along a path from a node to the root node. The battery life 714 field can be in the form of, for example, a percentage value (a number from 0 to 100). In an embodiment of the present invention, the battery life 714 reported at any node is the least battery life of a node that lies on the link between the node and the root node. Therefore, the battery life 714 can be calculated as:

BatteryLife(N)=Min(BatteryLife(PN), BatteryLife_{act}(N))

where:

N is a node in a Wireless Sensor Network for which the battery life is to be calculated;

PN is the parent node associated with the node N;

RN is the root node in the Wireless Sensor Network;

BatteryLife(N) is the battery life at a node N;

BatteryLife(PN) is the battery life of the parent node PN of the node N, as reported in a beacon received from the parent node PN;

BatteryLife_{act}(N) is a measure of the actual battery life of the node N as reported by the battery.

Therefore the battery information for a particular node is the lowest battery life of all the nodes between the node and the root node.

The traffic level 716 field indicates the amount of traffic passing through a node. The traffic level 716 field can be in the form of a percentage value (a number from 0 to 100). The traffic level 716 field value of 0 can indicate that the node is receiving no traffic from its children nodes or that it does not have any children nodes. The traffic level 716 may be calculated by determining the percentage of occupied wake-up intervals between two consecutive beacons. It should be apparent to those skilled in the art that the fields shown in FIG. 7 are for illustrative purposes only and can change based on the network level parameters that need to be determined to be used in various embodiments of the present invention.

FIG. 8 is a flowchart illustrating a method for initial association of a node with another node in accordance with one embodiment of the present invention. The flow chart shows initial association of a node with a first parent node, as the node enters the network. At block 802, the node listens for beacons from a set of nodes that are within a communication range of the node. The set of nodes in the vicinity of the node are potential parent nodes of the node and are typically in the vicinity of the node. At block 804, the node extracts network level information from the beacons. Then, at block 806, the node determines a first parent node from the set of nodes or potential parent nodes using the network level information. The network level information that the node uses includes, but is not limited to, number of children, hop count, received signal strength indication, battery level, past wake-up time period and traffic level. For example, the first parent node may be a node from the set of nodes that has minimum number of children associated with it. This ensures that the node is not connecting to a heavily burdened node that will receive too much data and hence, drop packets sent by the node. In another embodiment, the first parent node may be a node from the set of nodes that has the smallest hop count. This ensures that the wireless network 100 does not become too distributed, and the number of hops to the root node remains low. At block 808, the node associates with the first parent node. It should be noted that the terminology ‘first parent node’ is only used for distinguishing the node from other nodes. As a convention, the first parent node for a node is the node to which it is associated. It will be apparent to those skilled in the art that due to the ad-hoc nature of the Wireless Sensor Network 100, any node can become the first parent node of the node. In another embodiment of the invention, the node may also select and maintain a set of second parent nodes. A second parent node is a redundant node to which the node connects. If the first parent node becomes unavailable or unfavorable, based on the network level information, the node associates with a second parent node from the set of second parent nodes. This is explained further in conjunction with FIG. 9 below.

FIG. 9 shows a table 900 that includes various fields received by a node in beacons from various nodes in a communication range of the node, in accordance with one embodiment of the present invention. A node can use the table 900 in order to determine the first parent node and the set of second parent nodes. The node receives beacon packets in the beacons received from the set of nodes in the communication range. The beacon packets are parsed to extract network level information of the set of nodes. Table 900 includes the node ID 702, the traffic level 716, number of children 706, battery life 714, the route tag 704 and the hot count 708 as defined in conjunction with FIG. 7. In order to become the first parent node of the node, a node from the set of nodes must comply with a first set of criteria. Further, to become a second parent node, a node in the set of nodes must comply with a second set of criteria. Any node from the set of second parent nodes is capable of becoming the second parent node and hence, any node from the set of second parent nodes must comply with the second set of criteria. These criteria define ranges or conditions on the network level information included in the beacons received from each of the set of nodes. In accordance to one embodiment of the invention, the conditions are:

RSSI>MIN_RSSI_THRESHOLD (i.e., the RSSI must be greater than a threshold)

Battery Life>MIN_BAT_THRESHOLD (i.e., the battery life must be greater than a threshold)

No. of Children<MAX_CHILD_THRESHOLD (i.e., the number of children connected to the node must be less than a threshold)

Traffic Level<MAX_TRAFFIC_THRESHOLD (i.e., the traffic level in the node must be less than a threshold)

Hop Count<MAX_HOP_COUNT (i.e., the node should not be too distant from the root node)

However, it should be apparent to those skilled in the art that the above criteria are neither exclusive nor exhaustive. In various embodiments of the present invention, some or none of the above criteria may be used.

As mentioned earlier, the RSSI is an indicator of the strength of the wireless signal between two nodes. If the signal strength between the two nodes is low, then the chances of packet loss is high. Hence, a path having low effective RSSI is not preferred. MIN_RSSI_THRESHOLD is a minimum threshold of effective signal strength between a node and the root node. RSSI may be expressed as a number from 0 to 255. An exemplary value of MIN_RSSI_THRESHOLD is 100 which means that an RSSI below 100 indicates a poor link which should not be used for sending data. If a node has a very low remaining battery life, it may not be preferable for the node to have additional children. MIN_BAT_THRESHOLD is the minimum threshold value of remaining battery life of a node to be associated with another node as a parent node. An exemplary value of MIN_BAT_THRESHOLD is 30%. The greater the number of children a node has, the greater is the contention for wake-up slots resulting in higher traffic level. Further, the greater the number of children, the greater is the possibility of burst data to be received. As a result, having a number of children greater than a threshold is not preferred. MAX_CHILD_THRESHOLD is the maximum threshold value of number of children a node can have so that an additional child node associates with the node. An exemplary value for MAX_CHILD_THRESHOLD is 5. If the traffic level at a node is high, it may not be preferable for the node to have additional children. Therefore, the MAX_TRAFFIC_THRESHOLD is a limit on the maximum traffic level at a node so that an additional child node associates with the node. An exemplary value of MAX_TRAFFIC_THRESHOLD is 60%. If the node is too distant from the root node, then data from that node will have to travel through more nodes and hence use more battery power. MAX_HOP_COUNT is the maximum value of hop count that a node can have for children to associate with the node. An exemplary value of MAX_HOP_COUNT is 4. The above thresholds can be applied to the network level parameters of table 900 received in beacons from the set of nodes in the communication range of a node. As can be seen from FIG. 9, only the nodes with node IDs 1, 2 or 4 satisfy all the criteria. Therefore, only the nodes with node IDs 1, 2 or 4 are capable of being a first parent node of any given node. In one embodiment, the Wireless Sensor Network 100 may be configured to have identical conditions in the first and second set of criteria. In that case, a node will select its set of second parent nodes from node IDs 1, 2 and 4 too. The node may then select parents based on the favorable values of network level information. For example, a node can select the node with node ID 1 as its first parent node as this node satisfies the set of criteria in the best possible manner, i.e., lowest traffic level, low number of children, highest battery life, and maximum RSSI. The method as described above is applicable when a new node joins the wireless network 100. In another embodiment, all nodes monitor the network level information of the node to which they are associated or connected, i.e., their first parent node and set of second parent nodes. When the network level information of the first parent node fails to meet the first set of criteria, the node chooses to disassociate from the first parent node, and associate with one of the set of second parent nodes to which it is connected. The list of second parent nodes is also periodically updated using the beacons received by the node, so that the list is up-to-date. This ensures that when the node changes its first parent node, it selects the best node from amongst the set of second parent nodes. This contributes to the ad-hoc nature of the Wireless Sensor Network 100 while conserving battery life. However, in certain cases, selecting a second parent node considering only the factors mentioned above can lead to loss of connectivity with the root node 102. For example, referring to FIG. 1, consider that the node 116 becomes unfavorable for associating with as a first parent node. The node 126 may listen to beacons from nodes within its communication range and decide that the node 124 is the best candidate for associating with as it happened to meet the first set of criteria. However, the node 124 is itself associated with the node 116. Therefore, instead of improving the network configuration, the node 126 has connected to a node that may not remain connected to the root node for long. The overall hop count for the node 126 has also increased. Therefore, in case a node needs to change its first parent node, it is preferred that the node find a node that provides an alternate path to the root node 102. A method for ensuring this is described in conjunction with FIG. 2 above and FIG. 10 below.

FIG. 10 is a flowchart illustrating a method for changing the first parent node in accordance with one embodiment of the present invention. At block 1002, a node listens for a beacon from a first parent node to which it is associated. At block 1004, the node extracts network level information from the beacon. At block 1006, the node determines whether the network level information of the first parent node complies with a third set of criteria. The third set of criteria is a set of conditions to determine whether the first parent node is favorable for sending data to. In one embodiment, the third set of criteria is the inverse of the first set of criteria. In accordance to one embodiment of the invention, the third set of criteria are:

RSSI<=MIN_RSSI_THRESHOLD

Battery Life<=MIN_BAT_THRESHOLD

No. of Children>=MAX_CHILD_THRESHOLD

Traffic Level>=MAX_TRAFFIC_THRESHOLD

Hop Count>=MAX_HOP_COUNT

However, it should be apparent to those skilled in the art that the above criteria are neither exclusive nor exhaustive. In various embodiments of the present invention, some or none of the above criteria may be used.

If the first parent node does not comply with any one of the third set of criteria, then the step depicted in block 1008 is performed. Block 1008 depicts the step of waiting for the next beacon. This means that the node checks the status of the first parent node on receiving each beacon. To further conserve battery power, the node may check the network level information with the third set of criteria once in 5 or 10 beacons or when it transmits some data to the first parent node. If the first parent node complies with any one of the third set of criteria, the first parent node is considered unfavorable or unsuitable for data transmission. At block 1010, the node selects a second parent node from set of second parent nodes to which it is connected. This selection may be performed by identifying the most favorable amongst the set of second parent nodes. The node then disassociate from the first parent node at block 1012, and at block 1014, associates with the second parent node selected at block 1010. At block 1016, the node sets its route tag as the route of the second parent node. The route tag ensures that the second parent node is along a path to the root node disjoint from the path to the root node through the first parent node. This is explained earlier in conjunction with FIG. 2. From this point onwards, the second parent node starts acting as the active or first parent node of the node. This method is explained further in conjunction with FIG. 11.

FIG. 11 shows association of a node with a new parent node, in accordance with one embodiment of the present invention. FIG. 11a shows a part of the Wireless Sensor Network 100. FIG. 11a shows the node 126 associated with the node 116 as its first parent node and connected to the node 118 as its second parent node. The node 126 has the nodes 136 and 138 as its child nodes. The route tag of the node 116 is 2 as it is connected to the node 106 which has its route tag is 2. As a result, the node 126 which is its child node also has 2 as its route tag. The nodes 136 and 138 also inherit 2 as their route tag. If the node 126 determines that the node 116 meets its third set of criteria and is hence not favorable, it will disassociate with the node 116 and connect to the node 118 which is its second parent node. FIG. 11b shows the part of the network 100 shown in FIG. 11a after the node 126 has disassociated with the node 116. It should be noted that the node 126 inherits the route tag of the node 118 which is 3. Further, the nodes 136 and 138 also inherit the route tag from node 126. In another embodiment, the node 126 may also determine and connect to another second parent node with a different route tag. As shown in FIG. 11b, the node 126 has determined that the node 114 meets the second set of requirements and has a route tag different from that of its first parent node (now the node 118). As a result the node 126 connects to the node 114.

Various embodiments of the present invention as described above offer numerous advantages over existing schemes of operation in Wireless Sensor Networks. Various embodiments reduce the overall consumption of power in nodes of Wireless Sensor Networks, while providing high mobility of nodes within the network, adding the ability to handle burst data and avoid excessive packet drops. A method for ensuring that circular paths do not form in the network is also provided. This method is computationally simpler than other conventional methods and can be implemented easily.

While the foregoing is directed to embodiments of the present invention, other and further embodiments of the invention may be devised without departing from the basic scope thereof, and the scope thereof is determined by the claims that follow.

What is claimed is:

1. A method for reducing power consumption in a Wireless Sensor Network, the Wireless Sensor Network having a plurality of nodes, wherein at least one node is associated with a first parent node and a set of child nodes in the plurality of nodes, the method comprising:
generating network level information of the node;
determining an interval between periodic radio wake-ups based on the network level information; and
scheduling the radio wake-ups based on the interval.

2. The method according to claim 1, wherein the network level information comprises at least one of number of children, traffic level, hop count, received signal strength indication, battery level, and past wake-up time period.

3. The method according to claim 1 further comprising periodically broadcasting a beacon to the set of child nodes, wherein the beacon comprises the network level information.

4. The method according to claim 3 further comprising setting a different interval of periodically broadcasting the beacon to the set of child nodes, if the set of child nodes of the node is empty.

5. The method according to claim 1 further comprising transmitting data to the first parent node.

6. The method according to claim 1 further comprising setting route tag of the node same as route tag of the first parent node.

7. The method according to claim 6 further comprising connecting to a second parent node, wherein route tag of the second parent node is different from the route tag of the first parent node.

8. The method according to claim 7, further comprising:
associating with the second parent node if the node does not receive at least one beacon from the first parent node in a predefined time period; and
disassociating from the first parent node.

9. The method according to claim 1 further comprising disassociating from one or more of the set of child nodes when a battery level of the node reduces below a threshold battery level.

10. A method for reducing power consumption in a Wireless Sensor Network, the Wireless Sensor Network comprising a plurality of nodes forming a tree structure, the method comprising:
at a node, listening for beacons from a set of nodes that are within a communication range of the node;
determining network level information using the beacons received from each of the set of nodes;
determining a first parent node from the set of nodes, wherein network level information of the first parent node complies with a first set of criteria; and
associating with the first parent node.

11. The method according to claim 10 further comprising:
determining a set of second parent nodes from the set of nodes, wherein the network level information of each of the set of second parent nodes complies with a second set of criteria; and
connecting to the set of second parent nodes.

12. The method according to claim 11, wherein the step of determining the set of second parent nodes comprises selecting the set of second parent nodes such that the first parent node and each of the set of second parent nodes have disjoint paths to a root node of the tree structure.

13. The method according to claim 10, wherein the network level information comprises at least one of number of children, hop count, received signal strength indication, battery level, past wake-up time period and traffic level.

14. A method for reducing power consumption in a Wireless Sensor Network, the Wireless Sensor Network comprising a plurality of nodes forming a tree structure, wherein a node is associated with a first parent node, the method comprising:
at the node, determining network level information of the first parent node, wherein the network level information of the first parent node comprises a route tag of the first parent node, wherein a route tag signifies a disjoint path to a root node;
listening for beacons from a set of nodes that are within a communication range of the node;
determining network level information of each of the set of nodes, wherein the network level information of each of the set of nodes comprises a route tag of each of the set of nodes;
determining a set of second parent nodes from the set of nodes, wherein each node from the set of second parent nodes complies with a second set of criteria, and wherein route tags of each node from the set of second parent nodes and the first parent node are distinct;
connecting to the set of second parent nodes;
when network level information of the first parent node complies with a third set of criteria:
selecting a second parent node from the set of second parent nodes;
disassociating from the first parent node;
associating with the second parent node; and
setting route tag of the node same as route tag of the second parent node.

15. The method according to claim 14, wherein the network level information comprises at least one of number of children, hop count, received signal strength indication, battery level, past wake-up time period and traffic level.

16. The method according to claim 14 further comprising:
generating network level information of the node;
determining an interval between periodic radio wake-ups based on the network level information; and
scheduling the radio wake-ups based on the interval.

17. The method according to claim 14 further comprising periodically broadcasting a beacon to a set of child nodes, wherein the beacon comprises the route tag of the node.

18. A wireless sensor node comprising:
at least one sensor capable of sensing a parameter;
at least one transceiver for transmitting and receiving wireless signals, wherein the wireless signals comprise beacons and sensed parametric data;
a signaling module for adaptively controlling a wake-up interval of the transceiver based on network level information determined using the beacons; and
a processing module for managing connections with other nodes based on the network level information.

19. The wireless sensor node according to claim 18, wherein the network level information comprises at least one of number of children, hop count, received signal strength indication, battery level, past wake-up time period, route tag and traffic level.

20. A Wireless Sensor Network comprising:
a gateway capable of accumulating and forwarding data;
a plurality of nodes forming a tree structure with the gateway as a root node, wherein
the plurality of nodes comprises:
a set of first level nodes associated to the gateway, wherein each of the set of first level nodes is characterized by a unique route tag; and
a set of branches characterized in that:
each branch in the set of branches comprises one or more nodes;
each branch in the set of branches is associated with a distinct node from the set of first level nodes, whereby each branch in the set of branches is disjoint from other branches in the set of branches; and
each of the one or more nodes in a branch in the set of branches is characterized by a route tag that is same as the unique route tag of the distinct node to which the branch is associated.
